(19) United States
(12) Patent Application Publication
(10) Pub. No.: US 2009/0041905 A1
(43) Pub. Date: Feb. 12, 2009

(54) FROZEN FOOD PACK

(75) Inventors: Sarah Markillie, Auckland (NZ); Murray Taylor, Auckland (NZ); Julia Crownshaw, Mt Maunganui (NZ); Craig C. Winkelmann, Auckland (NZ); Christian Kaine Ross, Auckland (NZ)

Correspondence Address: KNOBBE MARTENS OLSON & BEAR LLP, 2040 MAIN STREET, FOURTEENTH FLOOR, IRVINE, CA, 92614, US

(73) Assignee: FONTERRA CO-OPERATIVE GROUP LIMITED, AUCKLAND (NZ)

(21) Appl. No.: 11/914,121

(22) PCT Filed: May 10, 2006
(86) PCT No.: PCT/NZ2006/000106

§ 371 Date: Oct. 9, 2008

(30) Foreign Application Priority Data
May 11, 2005 (NZ) 539964
May 11, 2005 (NZ) 539965
Nov. 1, 2005 (NZ) 543361
Feb. 7, 2006 (NZ) 545190

(51) Int. Cl. B65D 81/00; A23L 3/005

(52) U.S. Cl. 426/86; 426/234

(57) ABSTRACT

A microwaveable beverage pack comprising or including a free standing open top microwaveable container (with or without microwave shielding), having a piercable or removable lid that at least substantially closes the top of the container, and wherein said container contains a chilled or frozen composition microwaveable in the container to provide a hot foamed beverage. The container may include one or the other, or both of: (A) an opening as a vent, or an openable vent feature, in the container or lid, or both, to be above the level of the hot beverage composition and its foam in the free standing container, and/or (B) microwave shielding, integral with said container or as a separate apparatus, said microwave shielding to shield any of foam generated at the surface of the composition in the container when being microwaved.

### FIELD OF THE INVENTION

The present invention relates to a microwaveable beverage pack (preferably a frozen food pack). The pack is one in which a microwaveable beverage composition can be microwave heated and foamed and from part of which it can then be imbibed. More particularly but not exclusively it relates to a microwaveable beverage pack with optionally a microwaveable holder or support surround.

### BACKGROUND TO THE INVENTION

The present invention relates to a prepared prepacked chilled or frozen microwave heatable foam generating beverage composition.

Various frozen desserts such as ice creams are known in the separate ice cream or water ice art.

U.S. Pat. No. 4,840,813 states that it discloses low and non-fat aerated frozen dairy dessert and liquid mixes comparable to high fat ice creams, that, although milk-based, are low in fat.

Australian Patent No. 773330 states that it discloses a low temperature confectionary product comprising cocoa solids non fat, milk fat, cocoa butter, hard fat cocoa butter equivalent, water, sugar, milk solids non fat and wherein the percentage of milk fat and milk solids non fat is greater than or equal to 14%. As stated in Australian Patent No. 773330 such a product can be stored at low temperature or consumed either directly from the freezer, refrigerator, or at ambient temperatures.

Various methodologies for producing frozen dessert compositions to be eaten cold are also known.

U.S. Pat. No. 6,596,333 states that it discloses a process for the production of aerated frozen products by preparing a mixture of ingredients suitable for a frozen aerated product, adding an emulsifier mixture, aerating the mixture obtaining an aerated mix having an overrun of 20% to about 250% and then freezing the aerated mix to produce the aerated ice cream or water ice. Such products are eaten in their cold form.

Other ice cream products such as milk shake products are also known. Milk shakes are prepared prior to consumption and are consumed in a thawed or chilled state.

For example, U.S. Pat. No. 4,988,529 states that it discloses milk shake products that can be made from a special kind of ice cream stored in a normal freezer. As stated in this patent such a product requires beating by the consumer, with or without addition of syrup, prior to consumption still in a cold condition.

In the quite separate “instant” drink art powdered compositions requiring dissolution in water have been developed. Such powders have been form hot drinks such as instant coffee, hot chocolates etc have been known for some time. Generally such drinks require the consumer to add any dairy based products, such as milk, to the drink to obtain the desired taste.

U.S. Pat. No. 4,748,040 states that it discloses a powder-formed composition for preparation of a frothy beverage. U.S. Pat. No. 6,228,415 states that it discloses a method for preparing a hot beverage having a foamed milk-base topping. U.S. Pat. No. 6,228,415 discloses a product which is comprised of two separate components; a component as a tablet providing the beverage and a second component as a tablet providing the foamed milk-based topping. While such methods may be more convenient to a consumer than preparing and mixing the constituents from scratch, such products and methods still require considerable preparation.

Various “ready-to-drink” beverage products containing water and dairy products are also known in the art.

For example, U.S. Pat. No. 5,260,085 discloses an aqueous shelf-stable beverage product that utilises kappa carrageenin and chelating agents and/or propylene glycol alginate to stabilise the product. It is stated in U.S. Pat. No. 5,260,085 that such products can be stored for up to nine months at a temperature of between 1.6° C. to 32° C.

U.S. Pat. No. 5,955,136 states that it discloses low fat, shelf-stable, ready-to-drink milk shake beverages having the mouth feel of high fat milk shake beverages. Such beverages are stated to be shelf-stable for at least six months in non-refrigerated storage. U.S. Pat. No. 5,955,136 also states that such beverages are ready-to-drink, which means that they can be consumed directly from the container without any further preparation normally associated with powders and concentrates which must be reconstituted, or with freshly prepared products which must be made from scratch.

U.S. Pat. No. 6,180,159 states that it discloses a ready-to-drink beverage product that can deliver a rich, preferably frothy, foamy beverage with a clean improved mouth feel.

However, for the above “ready-to-drink” beverage products, consumption is of their room-temperature or chilled form. There is no disclosure in respect of the mentioned “ready-to-drink” products of a beverage pack and instruction for a consumer to heat the pack container as stored and its content to a frothy beverage, the pack including the same container from which they are to consume the beverage.

Disposable paperboard cups have been well known for a long period of time as, for example, in use in fast food outlets. Such cups may be used by themselves or in combination with a sipper cup (e.g. for children, the infirm or on aircraft) Generally the contents are poured into the cup already heated. Alternatively, a chilled or thawed liquid may be poured into such a cup and then heated. However, the heating of a beverage can result in overflowing of the liquid over the sides of such a cup. Furthermore, the consumer is required to dispense the liquid to be consumed into the cup, and this requires it to be liquid or spoonable, and then to heat it ensuring that it does not overflow.

We envisage as desirable a chilled or frozen hot beverage forming composition (preferably frozen) in a pack that includes a drinking vessel and at least a substantial or complete removable and/or pierceable closure that does not prevent, after heating, such vessel being used to contain the heated composition and to allow it to be imbibed as if from a cup and/or using a straw.

We envisage as desirable, as an aspect of the present invention, a foam generating composition (preferably as a result of a gas, e.g. air, overrun) able to be microwave heated in the pack whilst releasing vapours but not the thawed and heated composition as liquid or foam.

We envisage preferably vent provision for such pack forms not requiring care to prepare on the part of the user.

We have noted, as a result of our invention development, excessive loss of vapour resulting in decreased beverage content. This loss is attributed to foam being more susceptible to microwaves than the more dense still frozen and/or chilled remainder of the composition.

We propose, as an aspect of the present invention, a pack or ancillary means whereby the affect of continuing microwave exposure is reduced for foam in the upper portion of a container.

In unrelated art, New Zealand Design No. 403797 depicts a sealed container, wherein the seal completely seals the container and must be peeled back or removed to allow to access to the contents therein. Such containers are used to preserve the contents and allow the consumer to peel the lid of the containers immediately prior to consuming. The contents of such containers are generally consumed chilled or at room temperature.

In unrelated art, shielding or metallic sheets for reflecting or conducting microwave energy have been disclosed.

New Zealand Patent No. 229668 states that it discloses the use of composite sheet stock comprising a microwave susceptor sheet having a dielectric support layer and a heater layer of microwave interactive material that allows passage of microwave energy as it is heated thereby for the heating of food.

New Zealand Patent No. 227275 is stated to disclose the use of such microwave susceptible material to preferentially brown portions of food.

U.S. Pat. No. 4,233,325 relates to a pack of a dessert to be eaten as an ice cream having a thawed sauce thereon. There is a disclosure of microwave shielding to keep the underlying ice cream from being thawed with the covering sauce.

In unrelated art, US Patent Application No. 2004/0197442 discloses the use of venting holes that are created before cooking by piercing the top lid of a package before inserting it into a microwave oven, or by removing a protective label that covers the venting hole created during the packaging step. Also disclosed is a narrowing in a limited zone to create a weakness such that the seal will open up in the zone upon the generation of over-pressure. Further stated to be disclosed in US Patent Application No. 2004/0197442 is the use of multilayered thermoplastic material that has a peel strength such that the at least two layers are separated from one another, once sufficient pressure is generated upon heating, to thus allow the egress of gas/steam.

In our unpublished PCT specification PCT/NZ2005/000291, we have disclosed a frozen confection (preferably containing a dairy product), with incorporated air, that includes a composition capable in a container (and preferably the container in which it has been retailed) of being microwaved such that the composition is heated to a hot foamy beverage form. Such heating could be conducted with a removable lid that allows the foamy beverage to be drunk after microwave heating in an open cup.

In practise however, the opening of such a pack for the purpose of microwave heating a frozen confection with incorporated gas (preferably air) leads to soiling of both the microwave appliance and the exterior of the open container.

We therefore have developed a pack able to be microwaved as is or only slightly modified which avoids soiling and minimises content loss. That, with or without the composition of PCT/NZ2005/000291, is another aspect of the present invention.

This requires preferably both venting and foam retention and the latter is achieved preferably by both venting out of reach of the foam and by protecting the foam against microwaves or otherwise not subjecting the foam to excessive microwaves.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art

### OBJECTS OF THE INVENTION

It is an object of the present invention to provide a microwaveable beverage pack that satisfies one or more of the aforementioned desires, aspects or visions, or at least provide the public with a useful choice.

### SUMMARY OF THE INVENTION

We have noted that a heat foamable chilled or frozen composition presents the foam and the liquid/foam interface to microwave energy even as the chilled or frozen (particularly the frozen) composition continues to be heated by microwaves and generates vapour (including any entrained gas). This has lead to excessive loss of content owing to the low density of the foam relative to the liquid as vapours are vented. It is also detrimental to the foam. We have determined venting out of reach of the foam is desirable to minimise foam loss while releasing pressure.

In one aspect there is provided a beverage pack including or comprising a microwaveable container, said container capable, without opening, of being microwave heated in order to bring a chilled or frozen composition, with incorporated air, to a hot foamy beverage form.

Preferably said container includes a lid.

In a further aspect there is provided, as a product, a final drinking vessel in which a frozen or chilled beverage composition contained therein is able, despite lidding, to be microwave heated with little or no risk nor soiling potential.

Preferably said final drinking vessel or beverage pack includes a free standing, open top microwaveable container.

Preferably said lid is pierceable or removable.

Preferably said beverage pack or drinking vessel includes the utilisation of a venting feature for the “closed” container.

In one aspect of the invention there is provided a beverage pack comprising or including

an at least substantially closed self supporting container, and

a chilled or frozen composition in the container, the composition being able to generate a foam upon heating to a liquid form,

wherein the pack can be microwaved to heat the composition to a foamy beverage form,

and wherein the pack can be opened or penetrated to allow the drinking of the foamy beverage,

and wherein the container includes a venting feature.

Preferably said venting feature is above the level of the composition when (notionally or actually) liquid in the container, such venting feature able to allow venting of at least one gas from the container during heating and/or maintain gas until a desired temperature and resultant pressure is reached before allowing gas to be vented and/or thereafter without allowing any substantial egress of liquid and/or foam.

Preferably said beverage pack or final drinking vessel includes microwave shielding to shield any foam generated.

In a further aspect of the invention there is provided a microwaveable beverage pack comprising at least:

a free standing open top microwaveable container,

a pierceable lid or removeable lid, or both, at least substantially closing the top of the container, and

a chilled or frozen composition in the container microwaveable in the container to provide a hot foamed beverage,

wherein there is one or the other, or both of:
(A) an opening as a vent, or an openable vent feature, in the container or lid, or both, to be above the level of the hot beverage composition and its foam in the free standing container, and/or
(B) there is provided microwave shielding, integral with said container separate or as an apparatus said microwave shielding to shield any of foam generated at the surface of the composition in the container when being microwaved.

In one embodiment of the present invention either of (A) or (B) is present. Preferably both (A) and (B) are present.

In one embodiment of the invention said lid is removeable and the container is a drinking vessel.

Preferably, but not necessarily, said venting feature is in such a removable lid.

Alternatively the said container can be a container able to be penetrated by a straw or other like drinking apparatus and such penetration can be encouraged or not encouraged at or adjacent the venting feature. The venting feature can be in any suitable part of the container.

In some forms of the present invention, and preferably, there is a removable film, foil, or equivalent material lidding the top of a cup, it being an option of a user as to whether or not a straw is inserted through the film or not or whether or not the film is removed. The venting feature can be in any suitable part of the container.

In some forms the venting feature can be between a cup and a lid e.g. analogously to that venting feature of U.S. Pat. No. 6,164,484.

In one embodiment of the present invention said beverage pack or drinking vessel is capable of being heated without the requirement of removal of any seals or outer cover.

Preferably said lid includes at least one opening as a vent.

Preferably said venting feature is provided for by at least one or more of the following:
a piercing or piercings made prior to heating
a narrowing in a limited zone to create a weakness openable upon exertion of sufficient pressure during heating, or
the provision over at least part of said container of a feature comprising at least two layers having a peal strength such that when in a closed condition gas ingress or egress is inhibited, and wherein upon heating the pressure exerted internally of said feature exceeds the peel strength of the said at least two layers to allow gas egress.

In one embodiment of the present invention the venting feature is the form of a piercing. Preferably said piercing is in the form of a hole having a diameter in the range of between 0.2 and 0.8 mm. Preferably the diameter of the hole is 0.4, 0.5 or 0.6 mm. More preferably the diameter of the hole is 0.5 mm.

In one embodiment of the present invention said venting feature comprises more than one hole.

In one embodiment of the present invention said weakness creates a microperforate upon heating. It should be appreciated that said weakness could be incorporated in a container with or without a sealing by use of a foil.

In one embodiment of the present invention said container or drinking vessel is closed by a lid or other closure means. Preferably said closure means is a film, foil or other closure that is able to incorporate a venting feature. Preferably said film, foil or other closure is removable or able to be penetrated by the insertion of a straw or equivalent. If the container is closed with a seal or some other closure means, preferably the container may have its closure means removed to provide a cup, even if a sipper lid is to be applied.

Preferably the lidding is such that, with little or no risk nor soiling potential, it too is capable of being microwave heated.

Preferably said beverage pack or drinking vessel is capable of being heated without the requirement of removal of any seals or outer cover.

In one embodiment of the present invention said container has metal shielding about its upper region. Preferably said metal shield is a metal foil or material including a metal. Preferably said metal shield is formed, in its entirety or in part, from aluminium.

In one embodiment of the present invention said lid is of a microwave shielding material or is a lid which includes a microwave shielding material. Preferably said lid is of a metal foil or includes a metal.

In one embodiment of the present invention said lid is a pull off lid of aluminium foil or a pull of lid which includes aluminium.

Preferably there is shielding about the container separate from the lid, such shielding being from at or adjacent the surface of the chilled or frozen composition in the container up to the lid or adjacent the lid

In one embodiment of the present invention said metal shielding is present regardless of whether or not said container is used in conjunction with any said separate microwave shielding containing apparatus. Preferably said provided separate apparatus for microwave shielding is a stand/holder or surround.

In one embodiment of the present invention there is shielding about the container separate from the lid, such shielding being from at or adjacent the surface of the chilled or frozen composition in the container up to the lid or adjacent the lid.

In one embodiment of the present invention a wrap provides for both said lid and shielding up from at or adjacent the surface of the chilled or frozen composition in the container.

In one embodiment of the present invention there is provided a stand or holder with microwave shielding characteristics for use with or in combination with, as a product, a beverage pack or final drinking vessel, said beverage pack or final drinking vessel having a frozen or chilled beverage composition therein able, despite any lidding, to be microwave heated.

Preferably the container includes a sipper cap.

Preferably said a sipper lid is provided which is able to be engaged or re-engaged after said lid has been removed.

Preferably the composition prior to microwaving is frozen or has been frozen.

Preferably said composition is frozen

In less preferred forms of the present invention the composition is chilled at the time of commencement of microwave heating, or has never been frozen, but optionally and preferably has been chilled prior to the commencement of microwave heating.

Preferably the composition is a gas containing composition with a dairy content.

Preferably the gas in the composition is air but not necessarily so or solely so.

Preferably the composition is a composition provided as an oil in water type emulsion.

Preferably said composition is aqueous based solution with, by way of example, a composition including one or more dairy sourced products.

Preferably the frozen composition has spread there throughout at least one or more of:

(i) ice crystals of from 5 to 120 μm, but preferably from 5 to 30 μm,

(ii) fat globules of from 0.2 to 40 μm, and

(iii) air cells of from 5 to 185 μm, but preferably from 60 μm.

Preferably the composition has a stabiliser (e.g. Pectin), and at least one type of dairy inclusion.

Preferably protein is present (optionally as one dairy inclusion).

Preferably at least one source of carbohydrate is present.

In one embodiment of the present invention said composition, prior to freezing, comprises at least:

(i) a milk concentrate,

(ii) a milk protein extract (powder),

(iii) cream, and

(iv) carbohydrates.

Preferably a stabiliser is present (e.g. Pectin, Sodium Alginate, or the like).

Preferably the overrun is of from 10% to 120%, but preferably from 20% to 40%.

Preferably there is present at least 0.5% w/w colloidal proteins, 5% w/w carbohydrates and/or 0.01% w/w stabiliser(s).

In one embodiment of the present invention said composition prior to freezing has been a substantially homogenous mix of a gas(es) overrun [e.g. air overrun] composition of at least:

0 to 30% w/w colloidal protein(s) [e.g. selected from dairy base, vegetable based proteins, and/or a mix],

0 to 20% w/w fat(s) [e.g. selected from dairy and/or vegetable based fats],

0 to 40% w/w carbohydrate(s) [e.g. selected from sucrose, glucose, fructose, glycerin and/or any other carbohydrate used to supply solids and sweetness],

0 to 5% w/w stabilising agent(s) [e.g. selected from Pectin, CMC, Locust Bean Gum, Guar Gum, Sodium Alginate, Carrageenan, and/or Xanthan],

0 to 10% w/w flavouring(s) [e.g. selected from coffee, cocoa, chocolate, caramel, nut and/or any other flavouring substance],

0 to 90% w/w water.

Preferably there is at least 0.5% w/w colloidal protein(s).

Preferably there is at least 5% w/w carbohydrate(s).

Preferably there is at least 0.01% w/w stabilising agent(s).

Preferably said vessel or container, with said composition contained therein, is able to be microwave heated such that said composition is heated to a temperature in the range of from 50 to 95° C.

In one embodiment of the present invention said microwave heating of a said composition, from a frozen or chilled form to a temperature of from 50 to 95° C., avoids the undesired prospect of continued exposure of, in particular, the less dense foam (as well as the more dense gas entraining solid and ensuing liquid) to unnecessary microwave heating at the foam/liquid interface.

Preferably the container carries instructions on how the container (with or without modification) is to be microwave heated.

Preferably the container is formed primarily of paper or like material.

In still another aspect the invention is a heated foamy beverage in a vented container resulting from a use of a pack of any of the kinds as aforesaid or a method as aforesaid.

In one aspect the invention consists in the use of a stand or holder for a closed or open or vented or self venting drinking container of a frozen or chilled (preferably frozen) beverage composition to be microwave heated, such stand or holder having a microwave shielding capability which to surround the container thereby to provide shielding of the upper region thereof.

Preferably said stand or holder is free standing and preferably fully surrounds with a shielding region the vessel. Optionally the stand or holder supports the container in a microwave.

Preferably the stand or holder has a foil or other shielding material positioned as substantially a continuous (if not fully continuous) band about what will be the likely surface of the composition in the container as it is being heated thereby to protect the foam and liquid to foam interface from excessive microwave heating.

Preferably the stand acts in conjunction with a foil lid of the container (but preferably without arcing contact or proximity) to shield the foam and foam/liquid interface regions.

In still a further aspect the present invention consists in, in combination,

a stand or holder as previously defined with respect to its usage, and

a beverage pack being a frozen or chilled beverage composition in a container.

In still a further aspect the invention is a stand, holder or support as aforesaid or substantially as hereinafter described.

In yet a further aspect the present invention consists in a method of providing a foamy beverage which comprises or includes the steps of

taking a beverage pack of a kind as aforesaid,

heating the content of the unopened pack to a foamy beverage form with microwave energy, and

thereafter preparing the pack by lid removal, straw penetration or otherwise for the consumption of the heated foamy beverage.

Preferable the method includes placing the pack within a stand, holder or support having a shielding capability as aforesaid in a microwave.

Preferably the container is in the form of a film, foil or the like at least substantially sealed (“lidded”) cup able (even when surrounded by the shielding of the stand, holder or support) to allow microwave heating of at least part (preferably most) of its contained composition but shielding the foam and liquid/foam interface from at least some of the microwaves.

As used herein “and/or” refers to “and” or “or”.

As used herein “(s)” following a noun means the plural and singular forms of that noun.

As used herein “beverage” covers any fluid e.g. drinkable at least when heated.

As used herein “without allowing any substantial egress of liquid and/or foam” refers to the free standing pack as it usually would be disposed for microwave heating and/or carried therefrom.

The term “comprising” as used in this specification and claims means “consisting at least in part of”; that is to say when interpreting statements in this specification [and claims] which include “comprising”, features, other than those prefaced by this term in each statement, can also be present. Related terms such as “comprise” and “comprised” are to be interpreted in similar manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The present invention will now be described with reference to the accompanying drawings in which

FIG. 1 is a diagram to demonstrate ice crystal and emulsified fat surrounded air cells,

FIG. 2 is a cross section of a suitable microwave safe container wall,

FIG. 3 shows a cross-section of a simple pack in accordance with the present invention,

FIG. 4 shows one form of preferred pack in accordance with the present invention, there being a sipper cap overlying the peripheral bead of the rim of the paperboard cup, there preferably being a foil seal of the container under the sipper cap,

FIG. 5 is a perspective view of the preferred sipper cap in accordance with the present invention,

FIG. 6 is an exploded view of the paperboard container of FIG. 4, the foil seal for the top of the container, the sipper cap locatable over the sealed container, and a sleeve optionally to receive the container if there is a desire by that means to provide printed material and additional thermal protection and/or provide a cover for any underlying microwaveable shielding,

FIG. 7 is a plan view of the foil seal shown in FIG. 6, the foil seal being generally round but with a tear off tab and with a venting aperture,

FIG. 8 is a variation of the embodiment of FIG. 4 wherein in addition to the foil seal of FIG. 6 and FIG. 7 there is a foil or metallised film surround of the upper part of the paperboard container,

FIG. 9 shows how instead of a simple foil seal as shown in FIG. 7 a crimped closure arrangement of foil can be provided,

FIG. 10 shows a simple stand or holder in accordance with the present invention, and

FIG. 11 shows a combination of the stand or holder of FIG. 10 together with a container of FIG. 4, the combination of the holder and the container obviating the need for the additional shielding to a simple foil lidding described hereinafter in connection with FIGS. 8 and 9.

### DETAILED DESCRIPTION

A problem faced by consumers when heating foamed beverages is that as the beverage is heated, with a preferred ensuing production of foam, said foam is further heated unnecessarily. Even though the liquid content may still require microwave heating, the microwave energy is applied indiscriminately to the entire contents of the container, irrespective of whether it is appropriate that only part of the content is further heated. Excessive heating of the foam produced during microwave heating of a liquid can cause the foam to be dried or alter its taste. This is not satisfactory for a consumer who wishes to heat a frozen, or recently frozen, beverage to a hot foamy state, while retaining all aspects of taste and mouthfeel obtained when producing such drinks through conventional methods (e.g. cappuccino machine).

In a first aspect of the invention there is provided a beverage pack capable, without opening (and preferably without removal of any seals or outer cover), of being microwave heated in order to bring a chilled or frozen confection, with incorporated air, to a hot foamy beverage form.

Preferably said beverage pack includes the utilisation of a venting feature for the “closed” container. Preferably the venting feature is above the level of the composition when (notionally or actually) liquid in the container, as it would be positioned for microwave heating, is heated. The venting feature allows venting of the entrained gas and any other gases generated from the container during heating.

The present invention envisages such a container either being lidded or otherwise closed by a closure, [e.g. a film, foil or other closure that is vented, removable or able to be penetrated by the insertion of a straw or equivalent]. If the container is closed with a seal or some other closure means, preferably the container may have its closure removed to provide a cup, even if a sipper lid is to be applied.

We envisage as another or alternative aspect of the invention, as a product, a final drinking vessel in which a frozen or chilled beverage composition contained therein is able to be microwave heated (e.g. to a temperature in the range of from 50 to 95° C.) despite its lidding. Preferably the lidding is such that, with little or no risk nor soiling potential, it too is capable of being microwave heated.

As another or alternative aspect of the invention, from microwave heating of such beverage compositions from a frozen form to a temperature of from 50 to 95° C., is the avoidance of the undesired prospect of continued exposure of particularly the less dense foam (as well as the more dense gas entraining solid and ensuing liquid) to unnecessary microwave heating at the foam/liquid interface. A lack of control at the surface region of the composition does have a tendency to vent off content to the atmosphere as a result of at least the foam receiving microwave energy in excess of that demanded by its density to reach the desired overall temperature.

We also envisage as another or alternative object the provision of a stand or holder with microwave shielding characteristics for use with or in combination with, as a product, a final drinking vessel in which a frozen or chilled beverage composition is to be microwave heated (e.g. to a temperature in the range of from 50 to 95° C.) despite its lidding. Preferably the lidding is such, even without partial removal, whereby, with little or no risk nor soiling potential, it too is capable of being microwave heated albeit even if having a shielding function.

In one embodiment of the present invention there is provided a beverage pack that comprises or includes
an at least substantially closed self supporting container, and
a chilled or frozen composition in the container, the composition being able to generate a foam upon heating to a liquid form,

wherein the pack can be microwaved to heat the composition to a foamy beverage form,

and wherein the pack can be opened or penetrated to allow the drinking of the foamy beverage,

and wherein the container includes a venting feature.

In an alternative embodiment of the present invention there is provided a beverage pack that comprises or includes
an at least substantially closed self supporting container, and
a chilled or frozen composition in the container, the composition being able to generate a foam upon heating to a liquid form,

wherein the pack can be microwaved to heat the composition to a foamy beverage form,

and wherein the pack can be opened or penetrated to allow the drinking of the foamy beverage,

and wherein the container optionally (but preferably) includes a venting feature above the level of the composition in the container, such venting feature able to allow venting of at least one gas from the container during heating and/or maintain gas until a desired temperature and resultant pressure is reached before allowing gas to be vented and/or thereafter without allowing any substantial egress of liquid and/or foam.

In one aspect there is provided a microwaveable beverage pack comprising at least:

a free standing open top microwaveable container,

a pierceable lid or removeable lid, or both, at least substantially closing the top of the container, and

a chilled or frozen composition in the container microwaveable in the container to provide a hot foamed beverage,

wherein there is one or the other, or both of:
(A) an opening as a vent, or an openable vent feature, in the container or lid, or both, to be above the level of the hot beverage composition and its foam in the free standing container, and/or
(B) there is provided microwave shielding, integral with said container separate or as an apparatus said microwave shielding to shield any of foam generated at the surface of the composition in the container when being microwaved.

In one embodiment of the present invention either of (A) or (B) is present. Preferably both (A) and (B) are present.

Preferably said composition is a gas containing composition with a dairy content.

In one embodiment of the invention said lid is removeable and the container is a drinking vessel.

Preferably said composition is frozen

Sealed Air Corp discloses in US 2004/0197442 that in general the control of the pressure in the ovenable packages is achieved by creating at least one venting hole just before cooking, either by piercing the top lid of the package before inserting it in the oven or by removing the protective label covering the venting hole created during the packaging step. Alternatively the sealed area is narrowed in a limited zone to create a weakness in the seal so that the seal will open up in that zone upon the generation of the overpressure.

Sealed Air Corp also disclose in US 2004/0197442 that if a food product is packaged in a VSP (vacuum skin packaging) package made with microwaveable thermoplastic materials and the peel strength between the top skin web and the bottom support web is comprised between about 2.0 and about 4.0 N/25.4 mm, it is possible to thaw and/or cook, or re-heat, the packaged product in a microwave oven without the need of removing, loosening or perforating the top lid before putting the package into the oven, without any risk of explosion and avoiding any substantial stretching of the top skin web. The top skin web in fact will raise over the product by the pressure of the vapour released by the product or by the sauce accompanying the product but it will not be overstretched because a channel for the excess vapour to vent off will then be created, between the top skin and the bottom webs, from the packaged product to the outermost edge of the package. The top skin will remain raised over the product until the heating is on, allowing the steaming of the product, and will then return to its original position as soon as the heating is over.

They also disclose a self-venting microwaveable VSP package where a food product is vacuum skin packaged between a microwaveable rigid or semi-rigid support member, that can be flat or shaped, e.g. tray-, cup- or bowl-shaped, and a microwaveable top skin web which is draped over the food product, wherein the peel strength between the support member and the top skin web is comprised between about 2.0 and about 4.0 N/25.4 mm.

Preferably, but not necessarily, said venting feature is in such a removable lid.

Preferably said lid includes at least one opening as a vent.

Preferably said venting feature is provided for by at least one or more of the following:
a piercing or piercings made prior to heating
a narrowing in a limited zone to create a weakness openable upon exertion of sufficient pressure during heating, or
the provision over at least part of said container of a feature comprising at least two layers having a peal strength such that when in a closed condition gas ingress or egress is inhibited, and wherein upon heating the pressure exerted internally of said feature exceeds the peel strength of the said at least two layers to allow gas egress.

Preferably said piercing is in the form of a hole having a diameter in the range of between 0.2 and 0.8 mm. Preferably the diameter of the hole is 0.4, 0.5 or 0.6 mm. More preferably the diameter of the hole is 0.5 mm.

In one embodiment of the present invention said venting feature comprises more than one hole.

In one embodiment of the present invention said weakness creates a microperforate upon heating.

Preferably said lid is a film, foil or other closure that is able to incorporate said venting feature. Preferably said film, foil or other closure is removable or able to be penetrated by the insertion of a straw or equivalent. If the container is closed with a seal or some other closure means, preferably the container may have its closure means removed to provide a cup, even if a sipper lid is to be applied.

Preferably the lidding is such that, with little or no risk nor soiling potential, it too is capable of being microwave heated.

Preferably said beverage pack or drinking vessel is capable of being heated without the requirement of removal of any seals or outer cover.

In one embodiment of the present invention said container has metal shielding about its upper region. Preferably said metal shield is a metal foil or material including a metal. Preferably said metal shield is formed, in its entirety or in part, from aluminium.

In one embodiment of the present invention said lid is of a microwave shielding material or is a lid which includes a microwave shielding material. Preferably said lid is of a metal foil or includes a metal. Preferably said metal is aluminium. It should be appreciated that other metals could be used where appropriate such as silicon carbide, nickel, antimony, copper, molybdenum, bronze, iron, chromium, tin, zinc, silver, gold, alloys, etc.

In one embodiment of the present invention said lid is a pull off lid of aluminium foil or a pull of lid which includes aluminium.

Preferably there is shielding about the container separate from the lid, such shielding being from at or adjacent the surface of the chilled or frozen composition in the container up to the lid or adjacent the lid.

In one embodiment of the present invention said metal shielding is present regardless of whether or not said container is used in conjunction with any said separate microwave shielding containing apparatus. Preferably said provided separate apparatus for microwave shielding is a stand holder or surround.

In one embodiment of the present invention there is shielding about the container separate from the lid, such shielding being from at or adjacent the surface of the chilled or frozen composition in the container up to the lid or adjacent the lid.

In one embodiment of the present invention a wrap provides for both said lid and shielding up from at or adjacent the surface of the chilled or frozen composition in the container.

In one embodiment of the present invention there is provided a stand or holder with microwave shielding characteristics for use with or in combination with, as a product, a beverage pack or final drinking vessel, said beverage pack or final drinking vessel having a frozen or chilled beverage composition therein able, despite any lidding, to be microwave heated.

Preferably the container includes a sipper cap.

Preferably said a sipper lid is provided which is able to be engaged or re-engaged after said lid has been removed.

Preferably the composition prior to microwaving is frozen or has been frozen.

Preferably the composition is a gas containing composition with a dairy content.

In less preferred forms of the present invention the composition is chilled at the time of commencement of microwave heating, or has never been frozen, but optionally and preferably has been chilled prior to the commencement of microwave heating.

Preferably the gas in the composition is air but not necessarily so or solely so.

Preferably the composition is a composition provided as an oil in water type emulsion.

Preferably said composition is aqueous based solution with, by way of example, a composition including one or more dairy sourced products.

Preferably the frozen composition has spread there throughout at least one or more of:

(i) ice crystals of from 5 to 120 μm, but preferably from 5 to 30 μm,

(ii) fat globules of from 0.2 to 40 μm, and

(iii) air cells of from 5 to 185 μm, but preferably from 60 μm Preferably the composition has a stabiliser (e.g. Pectin), and at least one type of dairy inclusion.

Preferably protein is present (optionally as one dairy inclusion).

Preferably at least one source of carbohydrate is present.

In one embodiment of the present invention said composition, prior to freezing, comprises at least:

(i) a milk concentrate,

(ii) a milk protein extract (powder),

(iii) cream, and

(iv) carbohydrates.

Preferably a stabiliser is present (e.g. Pectin, Sodium Alginate, or the like).

Preferably the overrun is of from 10% to 120%, but preferably from 20% to 40%.

Preferably there is present at least 0.5% w/w colloidal proteins, 5% w/w carbohydrates and/or 0.01% w/w stabiliser(s).

In one embodiment of the present invention said composition prior to freezing has been a substantially homogenous mix of a gas(es) overrun [e.g. air overrun] composition of at least:

0 to 30% w/w colloidal protein(s) [e.g. selected from dairy base, vegetable based proteins, and/or a mix],

0 to 20% w/w fat(s) [e.g. selected from dairy and/or vegetable based fats],

0 to 40% w/w carbohydrate(s) [e.g. selected from sucrose, glucose, fructose, glycerin and/or any other carbohydrate used to supply solids and sweetness],

0 to 5% w/w stabilising agent(s) [e.g. selected from Pectin, CMC, Locust Bean Gum, Guar Gum, Sodium Alginate, Carrageenan, and/or Xanthan],

0 to 10% w/w flavouring(s) [e.g. selected from coffee, cocoa, chocolate, caramel, nut and/or any other flavouring substance],

0 to 90% w/w water.

Preferably there is at least 0.5% w/w colloidal protein(s).

Preferably there is at least 5% w/w carbohydrate(s).

Preferably there is at least 0.01% w/w stabilising agent(s).

Preferably said vessel or container, with said composition contained therein, is able to be microwave heated such that said composition is heated to a temperature in the range of from 50 to 95° C.

In one embodiment of the present invention said microwave heating of a said composition, from a frozen or chilled form to a temperature of from 50 to 95° C., avoids the undesired prospect of continued exposure of, in particular, the less dense foam (as well as the more dense gas entraining solid and ensuing liquid) to unnecessary microwave heating at the foam/liquid interface.

Preferably the container carries instructions on how the container (with or without modification) is to be microwave heated.

Preferably the container is formed primarily of paper or like material.

In one embodiment of the invention there is provided a stand or holder with microwave shielding characteristics for use with or in combination with, as a product, a beverage pack or final drinking vessel (for example, as described above), said beverage pack or final drinking vessel having a frozen or chilled beverage composition therein able, despite any lidding, to be microwave heated Preferably said lidding is such that even without partial removal, it too is capable of being microwave heated, albeit even if having a shielding function, with little or no risk nor soiling potential.

Preferably the container is in the form of a film, foil or the like at least substantially sealed (“lidded”) cup able to allow microwave heating of at least part (preferably most) of its contained composition but shielding from at least some of the microwaves foam generated from the composition by such microwave heating.

It should be appreciated that each of the characteristics relating to the container, its lid, shielding are equally applicable to a container used in conjunction with a holder/support.

In one aspect the invention consists in the use of a stand or holder for a closed or open or vented or self venting drinking container of a frozen or chilled (preferably frozen) beverage composition to be microwave heated, such stand or holder having a microwave shielding capability which to surround the container thereby to provide shielding of the upper region thereof.

Preferably said stand or holder is free standing and preferably fully surrounds with a shielding region the vessel. Optionally the stand or holder supports the container in a microwave.

Preferably the stand or holder has a foil or other shielding material positioned as substantially a continuous (if not fully continuous) band about what will be the likely surface of the composition in the container as it is being heated thereby to protect the foam and liquid to foam interface from excessive microwave heating.

Preferably the stand acts in conjunction with a foil lid of the container (but preferably without arcing contact or proximity) to shield the foam and foam/liquid interface regions.

In still a further aspect the present invention consists in, in combination,

a stand or holder as previously defined with respect to its usage, and

a beverage pack being a frozen or chilled beverage composition in a container.

In still a further aspect the invention is a stand, holder or support as aforesaid or substantially as hereinafter described.

In yet a further aspect the present invention consists in a method of providing a foamy beverage which comprises or includes the steps of

taking a beverage pack of a kind as aforesaid,

heating the content of the unopened pack to a foamy beverage form with microwave energy, and

thereafter preparing the pack by lid removal, straw penetration or otherwise for the consumption of the heated foamy beverage.

In yet a further aspect the present invention consists in a method of providing a foamy beverage which comprises or includes the steps of

taking a beverage pack of a kind as aforesaid,

heating the content of the unopened pack to a foamy beverage form with microwave energy, and

thereafter preparing the pack by lid removal, straw penetration or otherwise for the consumption of the heated foamy beverage.

In yet a further aspect the present invention consists in a method of providing a foamy beverage which comprises or includes the steps of
(i) taking a beverage pack of a kind as aforesaid,
(ii) placing the pack within a stand, holder or support having a shielding capability as aforesaid in a microwave,
(iii) heating the content of the unopened pack to a foamy beverage form with microwave energy, and
(iv) thereafter preparing the pack by lid removal, straw penetration or otherwise for the consumption of the heated foamy beverage.

Preferable the method includes placing the pack within a stand, holder or support having a shielding capability as aforesaid in a microwave.

It should be appreciated that any combination of container, venting, shielding, holder support as described above can be utilised

The invention enables a product that is made as a frozen system to be stored by wholesalers, retailers, caterers, or end users and then, when energy is applied, results in a beverage which is designed to be drunk hot. Examples of such a product have been made in Hot Chocolate and Coffee formats, has a formulation that allows ideal drinking parameters when hot. The product is manufactured, distributed and stored in a frozen state and has an extended shelf life. The process used to manufacture this product allows the formation and stabilisation of small air (or other gas e.g. nitrogen) cells in the system. On heating this results in a foamy layer in the product, which remains stable during consumption.

The consumer benefit from this product is a hot, thick, creamy, sweet and foamy drink, which is quick to prepare, and has an extended shelf life. It also has the benefit of real chocolate, coffee and fresh dairy ingredients which the powdered versions, which currently are the most popular form of take-home hot drinks, cannot always provide.

All percentages are on a W/W basis unless otherwise stated or apparent.

### EXAMPLE 1

A composition appropriate for use with the beverage pack of the present invention is exemplified below.

An example of a base formulation preferably used to make a composition able to be used with the beverage pack of the invention relies on separate components to provide desirable parameters in the final product. Basically the mix prior to freezing is a liquid with suspended fat globules, colloidal proteins, carbohydrates and salts. Agitation that is received by the mix as it is churned (scraped surface) allows air to be incorporated into the mix (overrun), and the formation of ice crystals allows this air to become stable. The fat cells become crystalline, and to an extent coalesce which results in a structure, which supports the air or gas cells in the mix. The ice crystals in this mix are around 5-120 μm, the fat globules 0.2-40 μm, and the air or gas cells typically 5-60 μm. The product is designed to be frozen down to approximately −20° C., and at that temperature 85%-90% of the water in the system should be frozen. Each ingredient of this mix has a specific purpose.

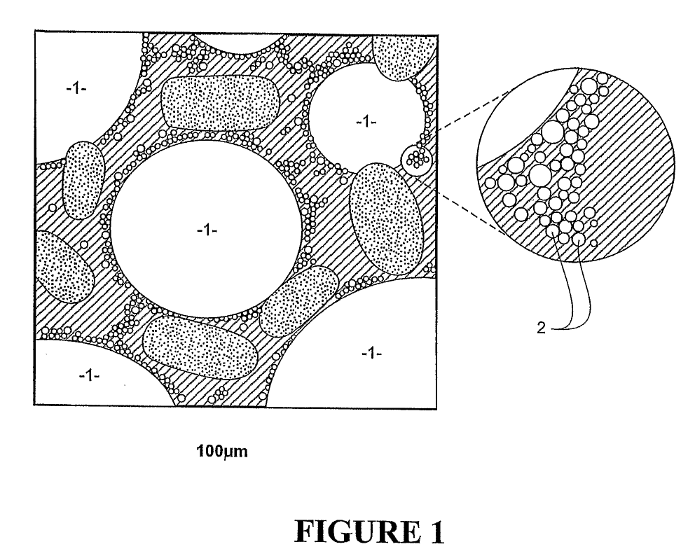

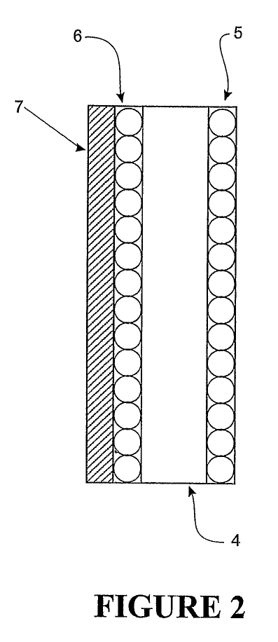

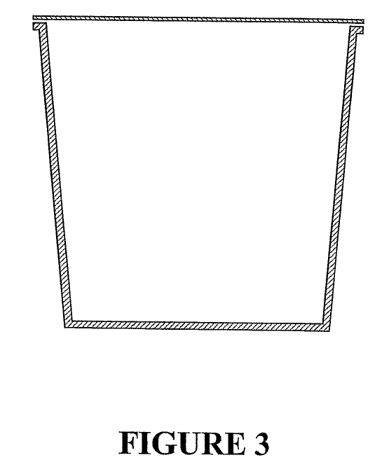

FIG. 1 shows air cells 1 surrounded by emulsified fat 2 and ice crystals 3.

### 1. Cream and MSNF

Dairy ingredients preferably typically male up 14-15% of the formulation. The cream and milk concentrate [i.e. MSNF (milk solids not fat)] supply the dairy flavour and the creamy texture often associated with indulgent hot chocolates and coffees.

### 2. Glucose

The level of sweetness used in this mix is lower than ice cream formulations as on heating the amount of sweetness the human palate can detect is increased, thus what tastes suitable frozen is too sweet when heated up. The level used in this mix is designed to be ideal at hot temperatures.

Glucose preferably is used at approx 19% and supplies solids without supplying too much sweetness, and also depresses the freezing point.

### 3. Cocoa Powders

Cocoa powders (and chocolate ingredients) preferably are used in these products to get a rich chocolate flavour and aroma. In a hot chocolate formulation several cocoa powders are preferably used and make up 1.5% of the formulation, in a Mochachino formulation preferably they supply 0.75% of the total mix, and in a coffee variant, preferably no cocoa powder is used

### 4. Chocolate

Real chocolate can and is preferably used in this formulation preferably at a level of approximately 2%. Its primary purpose is to give a rich, chocolate flavour and aroma, and to supply real chocolate content. Its presence may contribute to the fat and carbohydrate levels as well as flavourings.

### 5. Coffee

Coffee is used in a coffee version of this product to supply a coffee flavour and aroma, supply coffee content and caffeine. It is preferably used at a level of between 0.75-6.0%.

### 56. Protein Powder/Foam Stabiliser/Stabilising Agent

Protein powder is preferably used at a level of between 0.5-2.0%. This allows the air to be incorporated more readily on churning of the mix, and stabilisation of the air or gas cells once in the mix. This is done by the protein layering the interfacial layer between the aqueous phase and the air cell due to having both hydrophilic and hydrophobic portions, thus and causing stabilisation of the air or gas cell. The protein also results in a thicker, creamier mouth feel when the mix is heated.

By way of example, a caseinate [e.g. sodium caseinate] can be used as the foam stabiliser up to 2% W/w, more preferably up to 0.5% W/w [e.g. most preferably about 0.15% W/W sodium caseinate].

### 7. Pectin

Pectin is preferably used as a water binding stabiliser in this system and is used preferably at a level of 0.1-0.4%. It is a hydrocolloid, which helps to stabilise the air or gas cells in the system when the product is heated and consumed.

### 8. Sodium Citrate

When coffee is present there is a tendency for precipitation. This precipitation can be reduced by the presence of a chelating agent. Preferably the chelating agent (e.g. up to a level of 0.5% W/W) is a citrate such as sodium citrate. Most preferably the level of sodium citrate is about 0.1% W/W.

### 9. Other Flavours

Any other flavour and additive may be added as required in keeping with the nature of the product.

### 10. Preparation Method

This product is designed to be brought and stored frozen, and prepared just prior to consumption. The idea behind the preparation is that the stable system of ice crystals is turned into a hot liquid system by melting the ice crystals and heating them. This is to be done by the use of a microwave. The microwave's radio waves are absorbed by the water, fat and carbohydrate in the product, and as they are absorbed the energy is converted to heat, thus heating the frozen hot drink mix and changing it into the liquid state. These radio waves are not, however, to be absorbed by the container (e.g. of cardboard and/or plastic packaging material) resulting in a hot drink in a cup which is able to be held straight after heating by the consumer.

### 11. Packaging

The packaging that the hot drink mix preferably will be contained in is preferably a paperboard cup having a microwave proof coating (low density polyethylene) on the inside of the cup. The microwave proof coating aids in preventing moisture migration from the hot drink mix to the packaging. There is also a microwave proof coating (low density Polyethylene) on the outside of the cup to prevent moisture migration from the ice crystals that form on the cup during frozen storage.

Alternative cup materials can include single materials (e.g. a plastic such as polyethylene or other microwave resistant plastic) and laminates or blends of microwave resistant materials.

The lid or other closure can be of single or multiple parts. The lid may have two portions, a perforated plastic film, foil, or like seal for tamper evidence, and on top of that a thermoformed plastic perforated coffee lid, which can also be microwaved. In one form this top has a venting feature and the preferred seal (e.g. of film or foil, or both) is preferably also perforate sufficient to vent or is able to be pierced or have a tear off to allow venting.

The container has instructions on how the contained composition is to be microwave heated whether with or without modification of the pack.

FIG. 1 shows, by way of example, bleached kraft paperboard 4 having LDPE (5 and 6) extrusion coated (e.g. 15 gsm) on each side thereof and with scuff resistant low odour inks on its exterior 7.

Preferably the container is a cup form closed by a removable lid. Other forms however can be utilised including self supporting pouches or foil or otherwise sealed open topped containers.

In other forms of the present invention however any easily ruptureable or frangible weakness that serves the purpose can be utilised.

Alternatively an applied assembly or material can be provided over a perforate zone to achieve a like purpose.

Alternatively a tortuous path outlet can be provided which serves the purpose of the venting feature without allowing any direct ingress of contamination. This is a prospect particularly where the composition is to be maintained in a frozen state up until immediately prior to microwaving to the hot foamy beverage form.

Preferred heating is to a temperature in the range of from 50 to 95° C.

Preferably also, for safety if desired, a click fit sipper cap can be provided. Such as sippercap (typified by those frequently used on aircraft for safety purposes) can overlie a seal or substantial seal of the content of the container. See for example U.S. Pat. Nos. 3,868,043, 4,428,498 and 6,070,755. Preferably a seal to close or substantially close the container is provided in foil. Such a seal as a film or foil is preferably capable of being removed or pierced. The seal is preferably provided with a venting aperture (optionally tamper evident covered).

The shielding of microwaves to selectively heat in a microwave oven is a characteristic that is well known in the art. Such shielding is generally provided by provision of a conductive material such as foil or metallised plastics film.

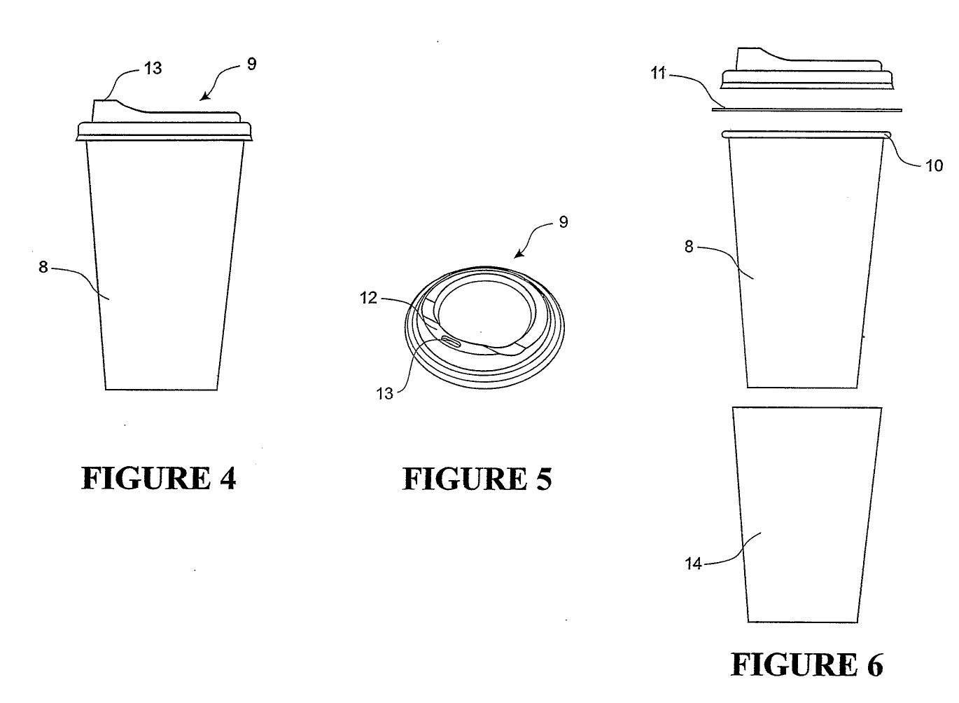

Examples of such shielding are disclosed in U.S. Pat. No. 6,903,320 of Mars, Inc (published previously as US 2004/0108313 1 Jun. 2004) and the aforementioned U.S. Pat. No. 4,233,325. U.S. Pat. No. 6,903,320 discloses a container for microwave thawing or heating of part of its content only reliant on shielding provided by selected parts of the container or foil associated therewith. FIG. 4 shows a preferred form of the present invention with a paperboard cup, preferably protected on each side with a polyethylene and having fitted thereto a sipper cap 9 which engages the bead 10 of the rim of the cup 8 preferably over the foil seal 11.

The sipper cap 9 of any appropriate plastic material (for example, a polyethylene) preferably has a raised spout region 12 with a sipper opening 13. In addition, if desired, another opening can be provided elsewhere in the sipper cap in order to facilitate the flow. This additional opening can be in the recessed region or on the other less raised region thereof.

In a preferred form of the present invention the sipper cap is dome or otherwise shaped so as to have the bulk of its body above the level of the cup save for engagement regions thereof.

The arrangement of FIG. 6 shows a sleeve 14 whether of paperboard material or a plastics material (could even be foam) which can receive the cup 8. Preferably the material of the sleeve 14 allows it to be microwaved together with the assembly.

FIG. 8 shows an assembly similar to that of FIG. 4 but having in addition to the foil 11, an additional foil or metallised film 15 to confer additional shielding beyond foil to any foam being created during the microwaving process. It is this same additional shielding that use of the stand or holder can obviate.

FIG. 9 shows a crimped or the like foil arrangement 16 that alternatively can be used in place of the removeable foil or metallised seal 11 and the surround 15. Such a capping of foil or the like 16 preferably has provision for venting either from the looseness of its fit or from a venting opening. Likewise this foil arrangement need not be used where there is use of the stand or holder.

The tear off seal 11 if not torn off prior to microwaving (and preferably it is not) includes a venting opening or plural openings. The opening 17 is sufficient to allow any steam or the like to issue from the composition as it is being microwaved.

Alternatives exist to the shielding arrangements depicted by reference to FIGS. 6 through 9 and these are within the scope of the present invention.

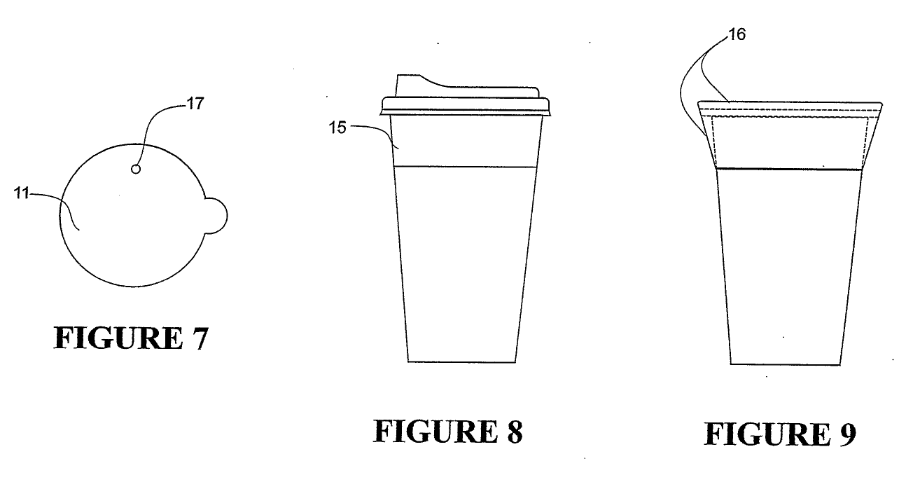

As can be seen, if the shielding is a tear off foil such as that depicted in FIGS. 7 and 11 and a surround of the foil such as 15 (whether incorporated during manufacture of the paper cup 8 or as an added material) preferably it is positioned so as not to detract from taste during the imbibing of the heated beverage. If desired, to avoid any metallic feel during consumption, a sleeve 14 can be fitted over the region 15 or alternatively an equivalent to the foil or other microwave shielding material 15 can be incorporated on the inside of the sleeve 14 rather than on the cup itself.

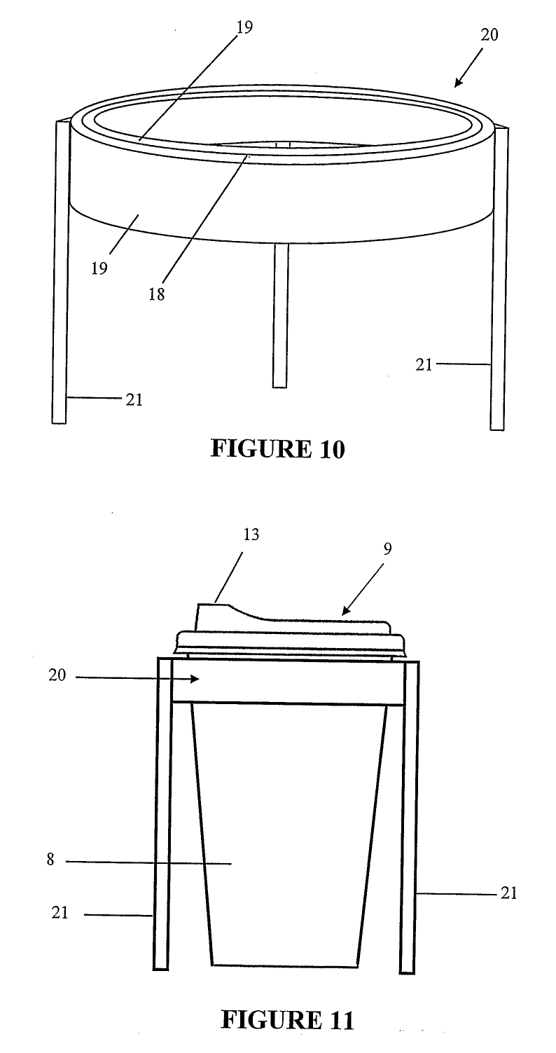

A preferred form of the present invention is the arrangement of FIG. 4 when used with a shielding stand or holder of FIG. 9, the result in the microwave being as shown in FIG. 10.

FIG. 9 shows the stand with a foil 18 (e.g. of aluminium) sandwiched between two durable plastic bands 19. Such a surround 20 is supported by legs 21.

FIG. 10 (optionally without the sipper cap 9 when in the microwave) shows the stand of FIG. 9 with its surround not sufficiently close to the lidding foil to cause difficulty but still providing shielding akin to that of embodiments of FIGS. 7 and 8. The stand can support the container with or without touching it.

In such ways it is possible to avoid any excessive loss of the foam during the microwave heating of the frozen composition.

It should be appreciated that as shown in Table 1 below, any combination of container:container shielding:holder:holder shielding can be utilised. For example, in one preferred embodiment a container is used in combination with a holder, both the container and holder utilising shielding. Alternatively a container may be used by itself utilising shielding, or a container (without shielding) may be used with a holder (with shielding).

TABLE 1
Table showing the different combinations of
container:shielding:sholder/support.

| | Holder/Support | Holder/Support with |
|---|---|---|
| | without shielding | shielding |
| Container without | ✓ | ✓ |
| shielding | | |
| Container with | ✓ | ✓ |
| shielding | | |

Although the invention has been described by way of example and with reference to particular embodiments, it is to be understood that modifications and/or improvements may be made without departing from the scope or spirit of the invention.

1. A microwaveable beverage pack comprising at least:
a free standing open top microwaveable container,
a pierceable lid or removeable lid, or both, at least substantially closing the top of the container, and
a chilled or frozen composition in the container microwaveable in the container to provide a hot foamed beverage,
wherein there is one or the other, or both of:
(A) an opening as a vent, or an openable vent feature, in the container or lid, or both, to be above the level of the hot beverage composition and its foam in the free standing container, and/or
(B) there is provided microwave shielding, integral with said container or as a separate apparatus, said microwave shielding to shield any of foam generated at the surface of the composition in the container when being microwaved, and
wherein there is shielding about the container separate from the lid, said shielding being adjacent the lid, and
wherein said composition has spread there throughout at least one or more of:
(i) ice crystals of from 5 to 120 μm,
(ii) fat globules of from 0.2 to 40 μm, and
(iii) air cells of from 5 to 185 μm.

2. (canceled)

3. (canceled)

4. (canceled)

5. A microwaveable beverage pack comprising at least:
a free standing open top microwaveable container having microwave shielding about the upper wall region thereof,
a pierceable lid or removeable lid, or both, at least substantially closing the top of the container, the lid being of or including a microwave shielding material; and
a foam generating composition microwaveable in the container,
wherein the wall shielding extends to at least adjacent to the lid,
and wherein there is an opening as a vent, or an openable vent feature, in the container or lid, or both, to be above the level of the hot beverage composition and its foam in the free standing container.

6. A pack of claim 5 wherein there is provided microwave shielding as a separate apparatus, said microwave shielding to shield any of foam generated at the surface of the composition in the container when being microwaved.

7. A pack of claim 5 wherein the composition is a gas containing composition with a dairy content.

8. (canceled)

9. A pack as claimed in claim wherein said composition is frozen.

10. (canceled)

11. (canceled)

12. A pack as claimed in claim 5 wherein said lid is a pull off lid of aluminum foil or a pull off lid which includes aluminum.

13. A pack of claim 5 wherein
a wrap provides for both said lid and shielding up from at or adjacent the surface of the chilled or frozen composition in the container.

14. A pack as claimed in claim 5 wherein a separate apparatus is provided for microwave shielding, said separate apparatus being a stand holder or surround.

15. (canceled)

16. A pack of claim 5 wherein said at least one opening is a single hole having an actual diameter or, if not round, a notional diameter in the range of between 0.2 and 0.8 mm.

17. A pack of claim 16 wherein the diameter actual or notional of the hole is 0.5 mm.

18. A pack of claim 5 wherein said vent feature is a weakness that microperforates upon heating of the pack by microwaves.

19. A pack of claim 5 wherein the gas in the composition is substantially air.

20. A pack of claim 5 wherein the composition is a composition provided as an oil in water type emulsion.

21. A pack of claim 5 wherein said composition has spread there throughout at least one or more of:
(i) ice crystals of from 5 to 120 μm,
(ii) fat globules of from 0.2 to 40 μm, and
(iii) air cells of from 5 to 185 μm.

22. A pack of claim 21 wherein said composition includes a protein.

23. A pack of claim 21 wherein said composition includes a carbohydrate.

24. A pack of claim 5 wherein said composition, prior to freezing, comprises at least:
(i) a milk concentrate,
(ii) a milk protein extract (powder),
(iii) cream, and
(iv) carbohydrates.

25. (canceled)

26. A pack of claim 24 that includes a stabiliser selected from any one or more of a pectin, sodium alginate, or the like.

27. A pack claim 5 wherein said composition has an air and/or gas overrun of from between 10% to 120%.

28. A pack of claim 5 wherein said composition has an overrun of from between 20% to 40%.

29. A pack of claim 5 wherein said composition prior to freezing has been a substantially homogenous mix of a gas(es) overrun composition of at least:
0 to 30% w/w colloidal protein(s) selected from dairy base, vegetable based proteins, and/or a mix,
0 to 20% w/w fat(s) selected from dairy and/or vegetable based fats,
0 to 40% w/w carbohydrate(s) selected from sucrose, glucose, fructose, glycerin and/or any other carbohydrate used to supply solids and sweetness,
0 to 5% w/w stabilising agent(s) selected from Pectin, CMC, Locust Bean Gum, Guar Gum, Sodium Alginate, Carrageenan, and/or Xanthan,
0 to 10% w/w flavouring(s) selected from coffee, cocoa, chocolate, caramel, nut and/or any other flavouring substance,
0 to 90% w/w water.

30. A pack claim 5 wherein said pack, with said composition contained therein, is able to be microwave heated such that said composition is heated to a temperature in the range of from 50 to 95° C.

31. A pack of claim 30 wherein microwave shielding ensures microwave heating avoids continued exposure of, in particular, the less dense foam to unnecessary microwave heating at or above the foam/liquid interface.

32. A pack of claim 5 wherein said container is formed primarily of paper material.

33. (canceled)

34. (canceled)

35. (canceled)

36. (canceled)

37. A method of providing a foamy beverage which comprises or includes the steps of:
taking a beverage pack of claim 1, and
heating the content of the unopened pack to a foamy beverage form with microwave energy,
and optionally, preparing the pack by lid removal, straw penetration or otherwise for the consumption of the heated foamy beverage.

38. A method of claim 37 including the step of placing the pack within a stand holder or surround to provide partial microwave shielding prior to and during microwave heating.

39. (canceled)

40. A method of claim 37 including the step of placing the pack within a stand holder or surround to provide partial microwave shielding prior to and during microwave heating.

41. A pack of claim 1 wherein a wrap provides for both said lid and shielding up from at or adjacent the surface of the chilled or frozen composition in the container.

42. A pack as claimed in claim 1 wherein said provided separate apparatus for microwave shielding is a stand holder or surround.

43. A pack of claim 1 wherein said at least one opening is a single hole having an actual diameter or, if not round, a notional diameter in the range of between 0.2 and 0.8 mm.

44. A pack of claim 43 wherein the diameter actual or notional of the hole is 0.5 mm.

45. A pack of claim 1 wherein said vent feature is a weakness that microperforates upon heating of the pack by microwaves.

46. A pack of claim 1 wherein the gas in the composition is substantially air.

47. A pack of claim 1 wherein the composition is a composition provided as an oil in water type emulsion.

48. A pack of claim 1 wherein said composition has an air and/or gas overrun of from between 10% to 120%.

49. A pack of claim 1 wherein said composition has an overrun of from between 20% to 40%.

50. A pack of claim 1 wherein said composition prior to freezing has been a substantially homogenous mix of a gas(es) overrun composition of at least:
0 to 30% w/w colloidal protein(s) selected from dairy base, vegetable based proteins, and/or a mix,
0 to 20% w/w fat(s) selected from dairy and/or vegetable based fats,
0 to 40% w/w carbohydrate(s) selected from sucrose, glucose, fructose, glycerin and/or any other carbohydrate used to supply solids and sweetness,
0 to 5% w/w stabilising agent(s) selected from Pectin, CMC, Locust Bean Gum, Guar Gum, Sodium Alginate, Carrageenan, and/or Xanthan,
0 to 10% w/w flavouring(s) selected from coffee, cocoa, chocolate, caramel, nut and/or any other flavouring substance,
0 to 90% w/w water.

51. A pack of claim 1 wherein said pack, with said composition contained therein, is able to be microwave heated such that said composition is heated to a temperature in the range of from 50 to 95° C.

52. A pack of claim 1 wherein microwave shielding ensures microwave heating avoids continued exposure of, in particular, the less dense foam to unnecessary microwave heating at or above the foam/liquid interface.

53. A pack of claim 1 wherein said container is formed primarily of paper material.

54. A method of providing a foamy beverage which comprises or includes the steps of:
taking a beverage pack of claim 5, and
heating the content of the unopened pack to a foamy beverage form with microwave energy.

55. A method of claim 54 additionally comprising preparing the pack by lid removal, straw penetration or otherwise for the consumption of the heated foamy beverage.

55. A method of claim 54 including the step of placing the pack within a stand holder or surround to provide partial microwave shielding prior to and during microwave heating.
